(19) United States
(12) Patent Application Publication
(10) Pub. No.: US 2026/0338530 A1
(43) Pub. Date: Oct. 29, 2026

(54) MODULAR BLANK DIE AND/OR CHECKING FIXTURE ASSEMBLY

(71) Applicant: MAGNA INTERNATIONAL INC., Aurora (CA)

(72) Inventor: Chris GLAMCEVSKI, Keswick (CA)

(21) Appl. No.: 19/123,131

(22) PCT Filed: Oct. 26, 2023
(86) PCT No.: PCT/CA2023/051427

§ 371 Date: Apr. 22, 2025

Related U.S. Application Data
(60) Provisional application No. 63/419,746, filed on Oct. 27, 2022.

(51) Int. Cl. G01B 5/20; G01B 3/00

(52) U.S. Cl. CPC G01B 5/20; G01B 3/00

(57) ABSTRACT

A modular blank die assembly and/or a checking fixture assembly includes a plurality of plastic molded blocks disposed in releasably interlocked relationship with one another to form a modular plastic frame. Each of the plurality of plastic molded blocks include at least one male connector disposed on a first side and at least one female connector disposed on a second side arranged opposite to the first side. The at least one male and female connector have complementary shapes for allowing the plurality of plastic molded blocks to be quickly and easily interconnected with one another to form the modular plastic frame. At least one working component is interconnected to the modular plastic frame to complete production of the blank die assembly or checking fixture assembly.

### CROSS-REFERENCE TO RELATED APPLICATIONS

This PCT International Patent Application claims the benefit of and priority to U.S. Provisional Patent Application Ser. No. 63/419,746, filed Oct. 27, 2022, titled “Modular Blank Die And/Or Checking Fixture Assembly,” the entire disclosure of which is hereby incorporated by reference.

### BACKGROUND OF THE INVENTION

### 1. Field of the Invention

The present invention relates to the manufacturing of vehicle parts. More particularly, the present invention relates to a blank die and/or checking fixture assembly for use during the manufacturing of vehicle parts.

### 2. Related Art

This section provides background information related to the present disclosure which is not necessarily prior art.

A method of manufacturing vehicle parts is traditionally accomplished by placing a single blank in between an upper blank die assembly and a lower blank die assembly to form a respective, single vehicle part. After the vehicle part is formed, it is often placed in a checking fixture assembly as a quality assurance step to confirm that the formed vehicle part meets the shape and contour requirements. As illustrated in FIG. 1, the prior art blank die assemblies are predominately comprised of a cast steel component that is a heavy structure (e.g., 15,000 to 20,000 lbs.) which requires a production lead time of 5-10 weeks, depending on the complexity. Although not expressly illustrated, the prior art checking fixture assemblies are also cast steel components that have the same product drawbacks. The lengthy production process includes the need for developing tailored foam patterns, a casting steel phase, and then a machining step of the raw cast material to obtain the resultant cast steel blank die assembly or checking fixture assembly, all which have attendant costs and add cycle time to the production process. The production process can also require weldments, screws and dowels, in many instances, adding further costs to the overall design. These heavy structures then require shipment to the manufacturing facility, adding freight to the overall cost of the blank die and/or checking fixture assembly. Further, each blank die or checking fixture assembly is uniquely designed for manufacturing a specific vehicle part, and thus must be discarded or recycled, after the vehicle program associated with the vehicle part is cancelled.

Accordingly, there is a continuing desire to develop a blank die and/or checking fixture assembly which reduces the overall product cost and lengthy lead times for production of the related assembly.

### SUMMARY OF THE INVENTION

According to an aspect of the disclosure, the subject invention is generally directed to a modular blank die assembly and/or a modular checking fixture assembly which each include a plurality of plastic molded blocks disposed in releasably interlocked relationship with one another to form a modular plastic frame. Each of the plurality of plastic molded blocks includes at least one male connector disposed on a first side and at least one female connector disposed on a second side that is opposite to the first side. The male and female connectors have complementary shapes for allowing the plurality of plastic molded blocks to be quickly and easily interconnected with one another to collectively build the modular plastic frame. At least one working component is interconnected to the modular plastic frame to complete production of the modular blank die and checking fixture assemblies. As examples, in the case of the modular blank die assembly, the at least one working component can include lift lugs, clamp slots, steel cutting sections, die heel blocks, guide pin blocks, skid (wear) blocks, nitro blocks, a lift table, or the like. Alternatively, in the case of the checking fixture assembly, the at least one working component can exemplarly include target plates, stanchions, risers, feeler holding clips, swing templates, locking pins, tooling ball holders, trim check aids, infomational plates, datum pins with holding blocks, fork lift pockets, feeler check holding units, tooling ball covers, and/or sliding check rails. In either arrangement, each working component includes at least one working connector that is shaped complementary to one of the male or female connectors to secure the working component to the modular plastic frame and complete production of the modular blank die assembly and the checking fixture assembly.

Construction of the modular die frame and/or checking fixture assembly with the plurality of plastic molded blocks to form the modular plastic frame eliminates the cast steel requirement (and the attendant costs and weights) from the prior art designs. Additionally, producing the modular die frame and/or checking fixture assembly out of a plurality of plastic blocks, that can be molded and stocked on the shelf for use as needed to assemble the modular die frame and/or checking fixture assembly, eliminates the long cycle times as well as the need for foam patterns and machining phases required when producing the prior art designs. Further, freight costs are reduced in the subject design as a result of the significant weight difference between plastic and steel. In summary, the modular die frame and/or checking fixture assembly provides an alternative to the cast steel prior art designs that provides reduced costs and production lead times, as well as increased flexibility.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 illustrates a prior art cast steel construction for a lower blank die assembly;

FIG. 2 illustrates a modular lower blank die assembly constructed in accordance with the principles of the subject invention and including a plurality of plastic molded blocks releasably interconnected with one another to build and form a modular plastic frame and a plurality of working components interconnected to the modular plastic frame;

FIG. 3 illustrates a modular upper blank die assembly constructed in accordance with the principles of the subject invention;

FIG. 4 is a top perspective view of an exemplary first one of the plurality of plastic molded blocks and illustrating a plurality of male connectors disposed on and extending from a first side of the plastic molded block;

FIG. 5 is a bottom perspective view of the exemplary first one of the plurality of plastic molded blocks and illustrating a plurality of female connectors on a second opposite side of the plastic molded block;

FIG. 6 is a top perspective view illustrating an exemplary second one of the plurality of plastic molded blocks;

FIG. 7 is a bottom perspective view of the exemplary second one of the plurality of plastic molded blocks;

FIG. 8 is a top perspective view illustrating an exemplary third one of the plurality of plastic molded blocks;

FIG. 9 is a bottom perspective view of the third one of the plurality of plastic molded blocks;

FIG. 10 is a top perspective view of an exemplary fourth one of the plurality of plastic molded blocks;

FIG. 11 is a bottom perspective view of the exemplary fourth one of the plurality of plastic molded blocks;

FIG. 12 is a top perspective view of a base layer of the modular plastic frame and illustrating the plurality of working components for the lower blank die assembly including a plurality of lift lugs, clamp slot pieces and connecting pieces each interconnected to the base layer;

FIG. 13A is a bottom perspective view of the base layer of the modular plastic frame;

FIG. 13B is an exploded bottom perspective view of a portion of FIG. 13A illustrating working connectors on the lift lugs, clamp slot pieces and connecting pieces;

FIG. 14 is a perspective view of the modular plastic frame and additionally illustrating the working components for the lower blank die assembly including steel cutting sections and die heel blocks connected to the modular plastic frame;

FIG. 15 is a magnified perspective view of a portion of the modular plastic frame more clearly illustrating the lift lug connected to a plastic molded block in the base layer of the modular plastic frame;

FIG. 16 is an alternative magnified perspective view of a portion of the modular plastic frame more clearly illustrating the lift lug and a clamp slot piece connected to the base layer of the modular plastic frame;

FIG. 17 is a magnified perspective view of a portion of the base layer of the modular plastic frame more clearly illustrating connecting pieces each having a recess for use in securing the clamp slots to the base layer;

FIG. 18A is a magnified perspective view of a portion of the modular plastic frame illustrating the working components of the lower die assembly additionally including a build-up block, shim block and steel cutting sections connected to the modular plastic frame;

FIG. 18B is a bottom perspective view of a steel cutting section illustrating the working connectors;

FIG. 19A is a magnified perspective view of a portion of the modular plastic frame for the lower die assembly illustrating the working components additionally including die heel blocks connected to the modular plastic blocks of the modular plastic frame;

FIG. 19B is a perspective view illustrating a bottom of the die heel block presenting working connectors;

FIG. 20 is a perspective view of a top layer of the modular plastic frame for the lower blank die assembly illustrating the working components additionally including skid blocks connected to the top layer of the modular plastic frame;

FIG. 21 is a persepctive view of a lift table as an additional working component for connection to the top layer of the modular plastic frame;

FIG. 22 is a magnified perspective view of a portion of the modular plastic frame of the upper die assembly to more clearly illustrate the guide pin block and heel block of the working components;

FIG. 23 is a persective view of a checking fixture assembly constructed in accordance with the principles of the subject invention and including a plurality of plastic molded blocks releasably interconnected with one another to build and form a modular plastic frame supported on a cart and including a plurality of working components interconnected to the modular plastic frame;

FIG. 24 is a magnified perspective view of a portion of the modular plastic frame for the checking fixture assembly illustrating the working components including target plates, stanchions and feeler holding clips interconnected to a base layer of the modular plastic frame;

FIG. 25 is a magnified perspective view of a portion of the modular plastic frame for the checking fixture assembly illustrating the working components additionally including a swing template and locking pin interconnected to the modular plastic frame;

FIG. 26 is a top magnified perspective view of a portion of the modular plastic frame for the checking fixture assembly illustrating the working components additionally including a tooling ball holder and informational plates interconnected to the base layer;

FIG. 27 is a magnified perspective view of a portion of the modular plastic frame for the checking fixture assembly illustrating the workking components additionally including trim check aids interconnected to the top layer; and

FIG. 28 is a magnified perspective view of a portion of the top layer of the modular plastic frame more clearly illustrating the feeler holding clip.

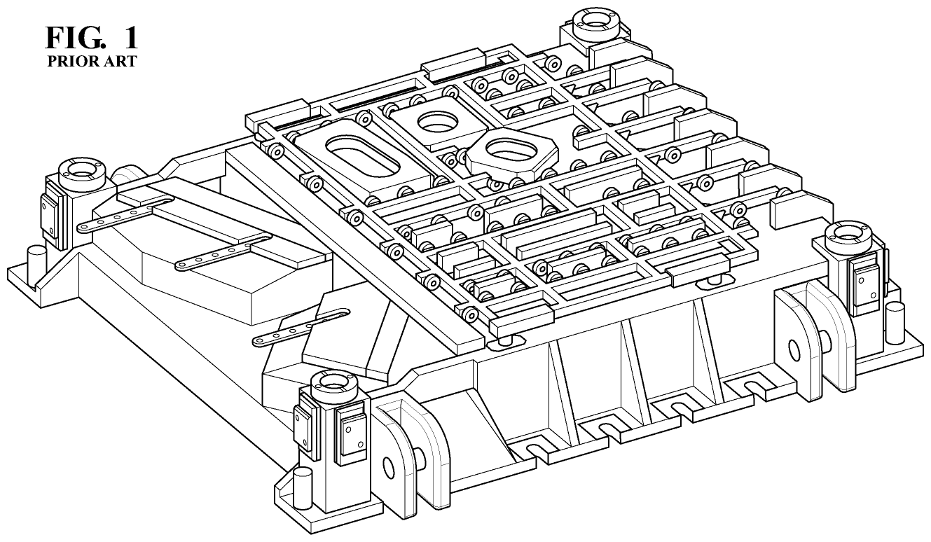

### DETAILED DESCRIPTION OF THE ENABLING EMBODIMENTS

Example embodiments will now be described more fully with reference to the accompanying drawings. In general, the subject embodiments are directed to a modular blank die assembly 10 and a checking fixture assembly 11. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In particular, although the modular blank die and/or checking fixture assemblies 10, 11 will be described in relation to manufacturing vehicle parts, it should be appreciated that the assemblies could also be utilized to form non-vehicle parts without departing from the scope of the subject disclosure. In some example embodiments, well-known processes, well-known device structures, and well-known technologies are not described in detail.

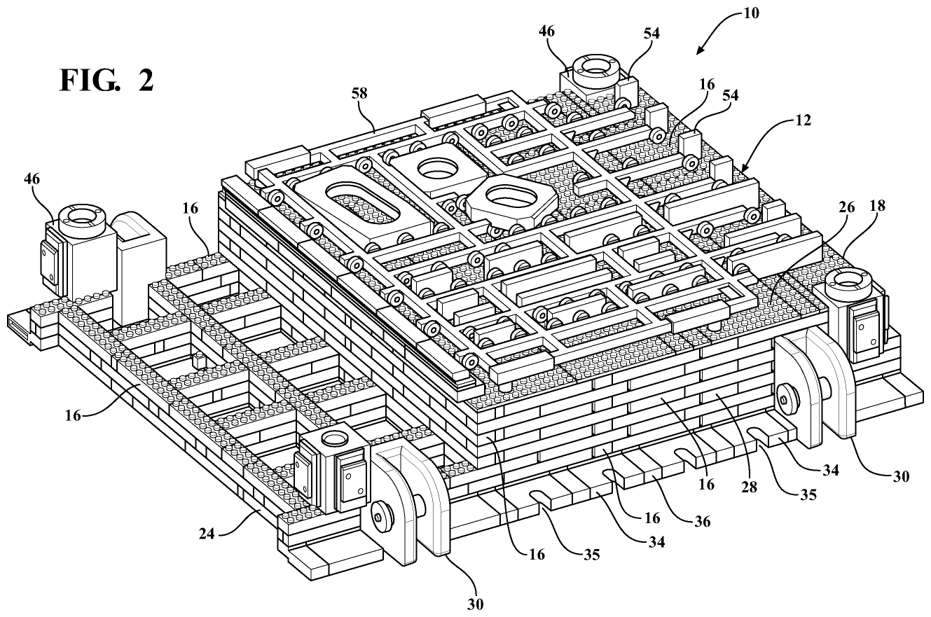

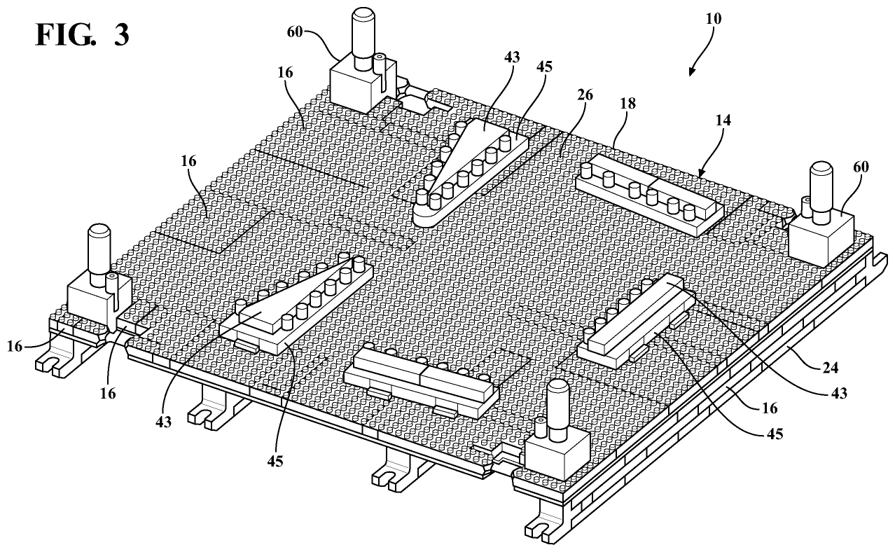

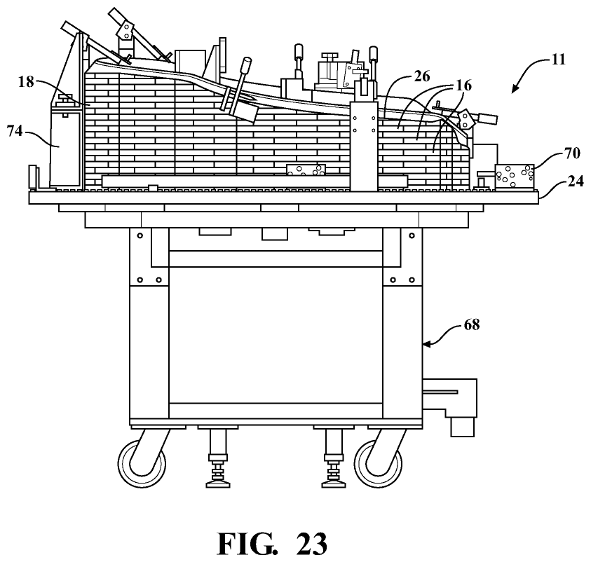

Referring to the Figures, a modular die frame assembly 10 is generally illustrated in FIGS. 2-3 and 12-14. As best illustrated in FIGS. 2-3, the modular die frame assembly 10 includes a modular lower die assembly 12 (FIG. 2) and a modular upper die frame assembly 14 (FIG. 3) for use in manufacturing a vehicle part, each constructed in accordance with the following principles. As illustrated in FIGS. 23-28, the principles of the modular design disclosed herein can also be applied to a modular checking fixture assembly 11.

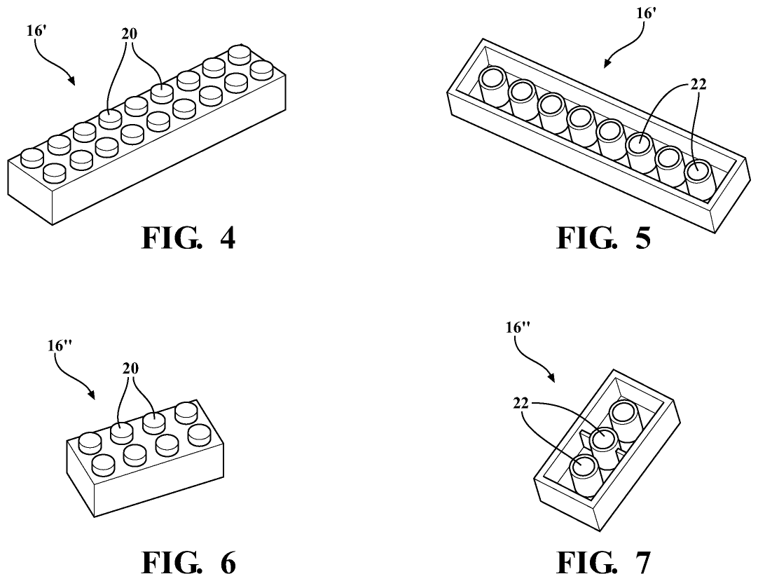

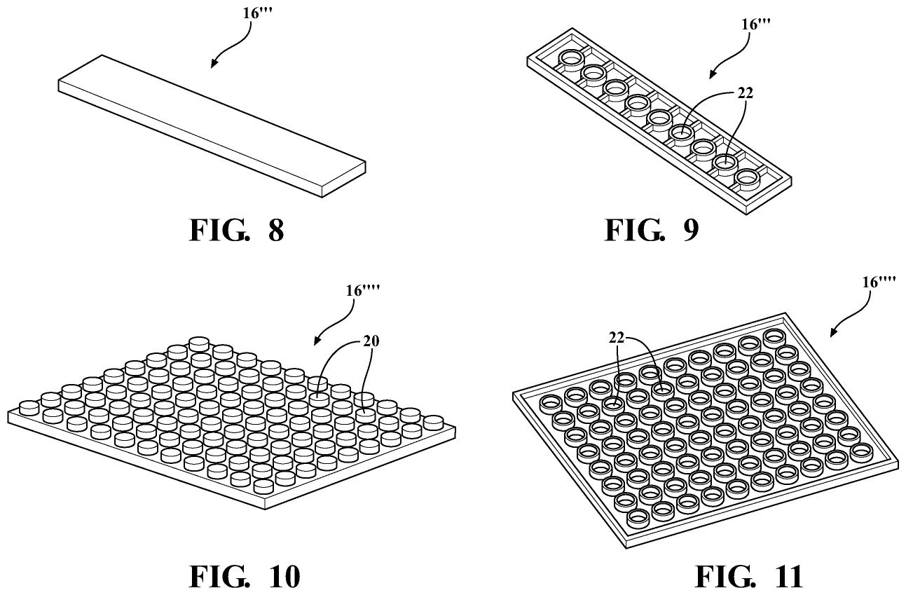

As best illustrated in FIGS. 2-3, 12, 14, 20, 23-25, and 27 each of the modular lower and upper blank die frame assemblies 12, 14, as well as the checking fixture assembly 11, are built from and include a plurality of plastic molded blocks 16 disposed in releasably interlocked relationship with one another to form a modular plastic frame 18. As best illustrated in FIGS. 4-11, each of the plurality of plastic molded parts 16′, 16″, 16″′, 16″″ have varying lengths, heights and widths (with the lengths, heights and widths shown in the Figures being exemplary and not limiting) to provide for flexibility in building a modular plastic frame 18 that is tailored to the needs of the upper and lower blank die frame assemblies 12, 14 of the modular blank die assembly 10 and/or the checking fixture assembly 11. In other words, each of these plurality of plastic molded parts 16′, 16″, 16″′, 16″″ are pre-molded construction blocks that can be stored/stocked on a shelf and then quickly assembled to form the modular plastic frame 18. The use of pre-molded plastic parts 16 for the modular blank die frame assembly 10 eliminates the requirement for the cast steel component and the extended lead time to produce same from the prior art designs. Further, since the plastic parts can be molded to an accurate size, the requirement to machine the modular plastic frame 18 once formed (as would be required in the prior art cast steel designs) is eliminated.

As further illustrated in FIGS. 4-11, each of the plurality of plastic molded parts 16 includes at least one male connector 20 disposed on and extending from a first (e.g., upper) side 21 and at least one female connector 22 disposed on a second (e.g., lower) side 23 that is arranged opposite to the first side 21. The male and female connectors 20, 22 have complementary cross-sectional shapes for allowing the plurality of plastic molded parts 16 for allowing the plurality of plastic molded parts to be quickly and easily interconnected with one another to build the modular plastic frame 18. In a preferred arrangement, the male and female connectors 20, 22 are complementary shaped to each have circular cross-sectional shapes. However, other means and complementary shapes, such as squares, rectangles, triangles, or the like, for establishing a releasable connection between the plurality of plastic molded parts 16 can be utilized without departing from the scope of the subject invention. Once the plurality of plastic molded parts 16 are releasably connected (e.g., snapped) together, the plastic molded parts 16 could be glued in place to eliminate the need for screws and dowels in the subject design.

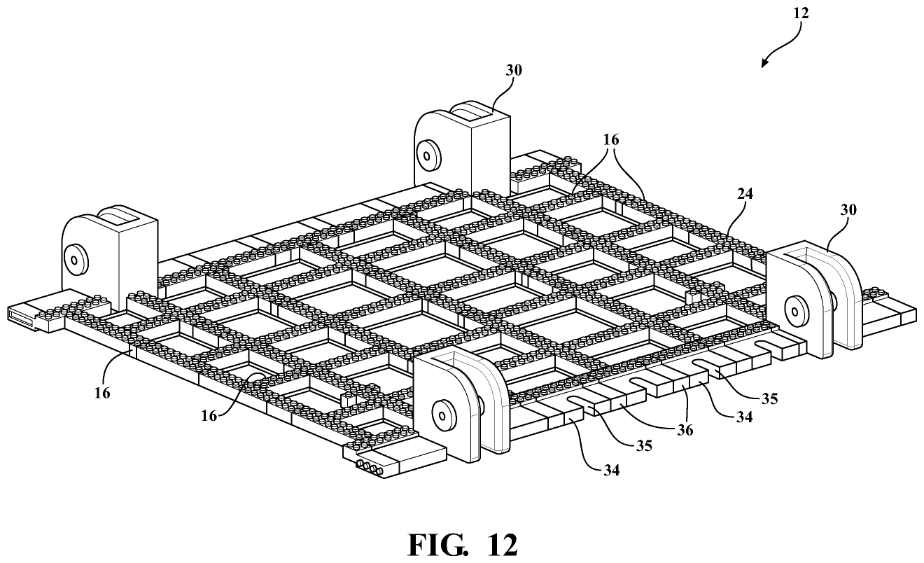

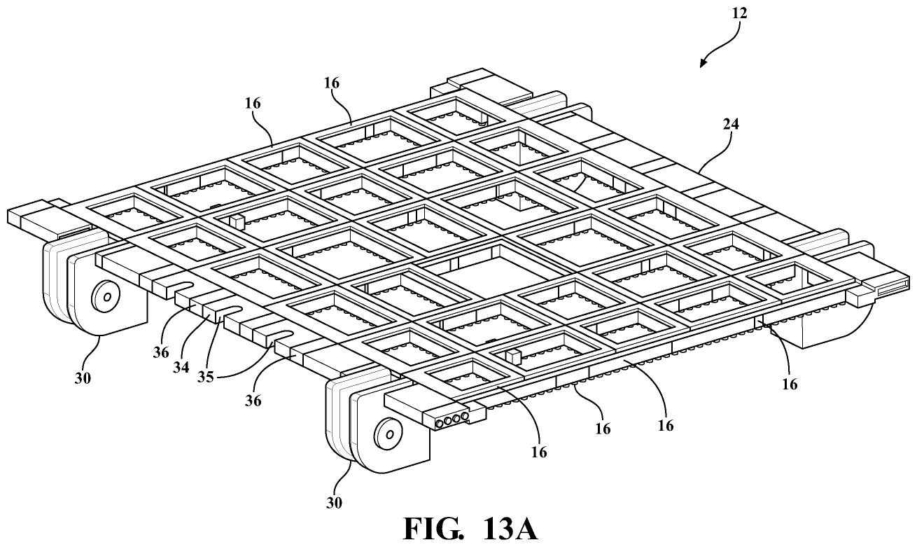

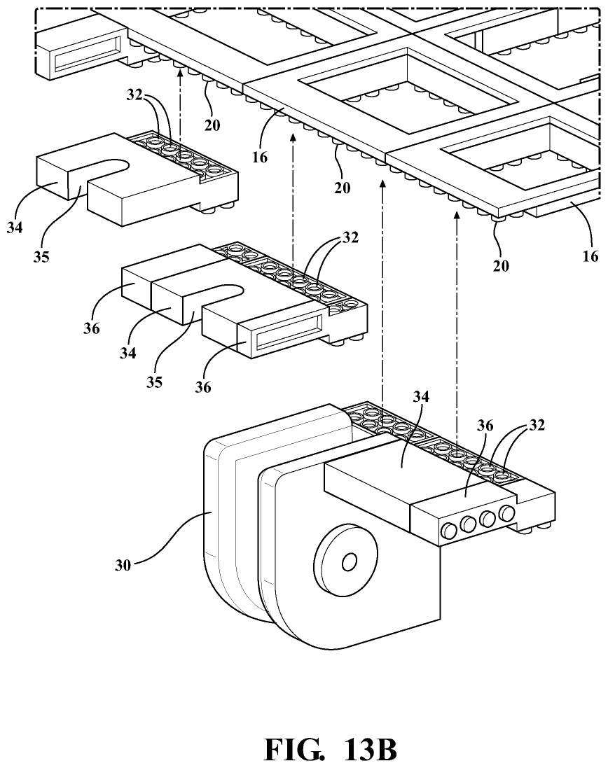

As best illustrated in FIGS. 12-22, the modular blank die assembly 10 includes a plurality of die assembly working components 30, 34, 36, 40, 42, 43, 44, 45, 46, 54, 56, 60 interconnected, preferably in a releasable manner, to the modular plastic frame 18 to complete production of the upper and/or lower blank die assembly 12, 14. Similarly, as illustrated in FIGS. 23-28, the checking fixture assembly 11 includes a plurality of checking fixture working components 70, 72, 74, 76, 78, 80, 82, 84, 86 interconnected, preferably in a releasable manner, to the modular plastic frame 18 to complete production of the checking fixture assembly 11. Each die assembly working component 30, 34, 36, 40, 42, 43, 44, 45, 46, 54, 56, 60 and each checking fixture working component 70, 72, 74, 76, 78, 80, 82, 84, 86 includes a working connector 32 that is shaped complementary to one of the male or female connectors 20, 22 on the plurality of plastic molded parts 16. For example, if the plurality of plastic molded parts 16 are releasably interconnected and stacked such that the male connectors 20 face upwards in the resultant modular plastic frame 18, such as shown in FIGS. 12, 14, 20, 24, 27, the working connector 32 on the working component(s) will have a complementary female shape to establish the interconnection. (See FIGS. 13B, 18B, and 19B). However, this complementary arrangement of the working connector 32 could be reversed if the female connectors 22 faced upwards on the plurality of interconnected plastic molded parts 16, without departing from the scope of the subject disclosure.

As will be appreciated in view of the following more detailed disclosure, the interconnection between the working component(s) and the modular plastic frame 18 allows each lower die assembly 12, upper die assembly 14, and. or checking fixture assembly 11 to be easily and quickly built and tailored to the specific needs of the vehicle part to be manufactured and tested. Assembly of the modular blank die assembly 10 and/or checking fixture assembly 11 can even be started after the production tools are stable. Furthermore, since each of the working components can be stored and stocked on the shelf, similar to the plurality of plastic molded parts 16, a lead time for producing the modular blank die assembly 10 and checking fixture assembly 11 is further reduced. Additionally, since plastic components are predominantly used to produce the modular blank die assembly 10 and checking fixture assembly 11, an overall weight can be reduced relative to the prior art designs. For example, in an embodiment the modular blank die assembly 10 could weigh approximately 3,000 lbs., in comparison to the 15,000 to 20,000 lb. weight of the prior art cast steel designs, as a result of producing the modular blank die assembly 10 from plastic instead of steel. Use of plastic not only provides reduced assembly costs (as a result of cheaper price of plastic vs. steel), but freight costs are further reduced (due to the weight different from steel to plastic) if the modular blank die assembly 10 and/or checking fixture assembly 11 requires shipment to the manufacturing facility.

As best illustrated in FIGS. 2-3, 14, 23, and 27 the modular plastic frame 18 comprised of the plurality of releasably connected and stacked plastic molded parts 16 extends from a base layer 24 to a top layer 26, and includes a pluarlaity of intermediate layers 28 disposed in sandwiched relationship therebweteen, all of which are formed from a plurality of plastic molded blocks 16. The plurality of die assembly working components 30, 34, 36, 40, 42, 43, 44, 45, 46, 54, 56, 60 and the plurality of checking fixture working components 70, 72, 74, 76, 78, 80, 82, 84, 86 are interconnected to the modular plastic frame 18, either to the base layer 24, to the top layer 26, or other intermediate layers 28 disposed in sandwiched relationship therebetween.

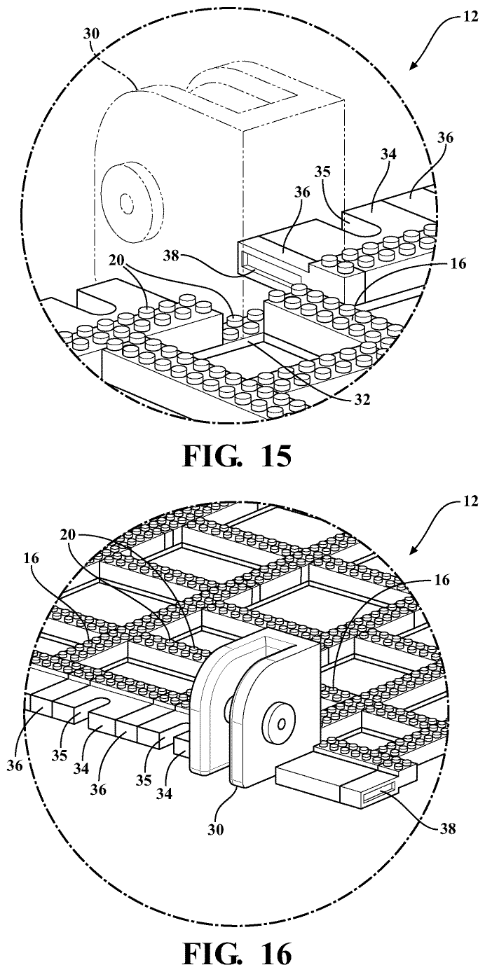

As illustrated in FIGS. 12-16, the plurality of working components 30, 34, 36, 40, 42, 43, 44, 45, 46, 54, 56, 60 for the modular die assembly 10 can include a plurality of lift lugs 30 interconnected to the base layer 24. Lift lugs in the prior art cast iron construction are integrally formed with die frame assembly. Yet, lift lugs 30 are designed specific and unique to a customer's standards. Thus, the ability to simply interconnect the lift lugs 30 to the base layer 24 (or any layer of the modular plastic frame 18, for that matter) allows the modular blank die assembly 10 to be easily tailored to the specific needs of the vehicle part, with minimal (or even no) changes to production process (as would be required in the case of the prior art cast iron construction). As further illustrated in FIGS. 13B and 15, the lift lugs 30 include the working connector 32 being female shaped complimentary to the male shape of the male connector 20 on the plurality of plastic molded parts 16 which make-up the base layer 24 for allowing the lift lug 30 to be releasably connected to the modular plastic frame 30.

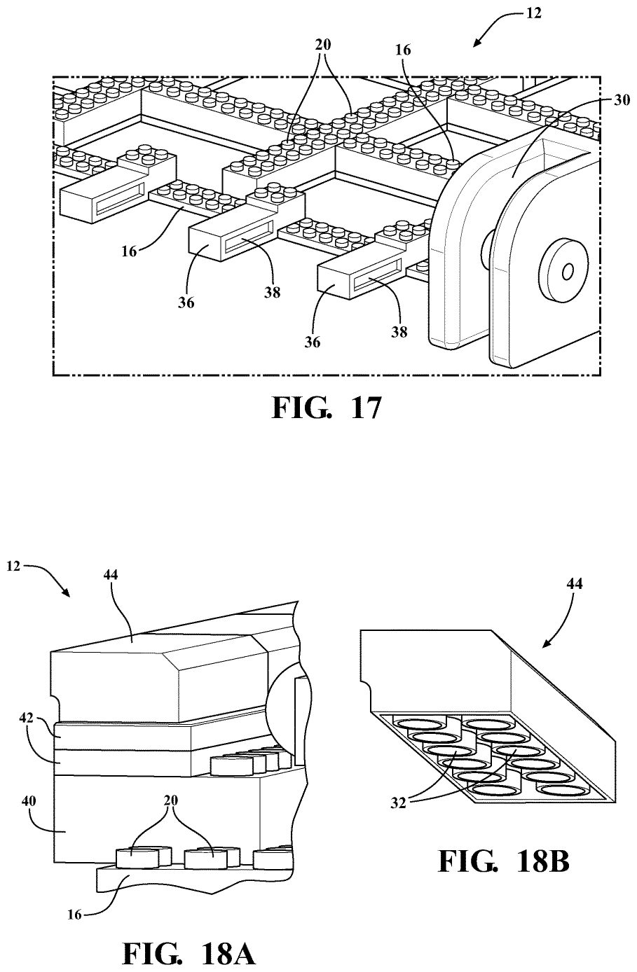

As illustrated in FIGS. 12-13A and 16, the plurality of working components 30, 34, 36, 40, 42, 43, 44, 45, 46, 54, 56, 60 for the modular die assembly 10 can also include a plurality of clamp slot pieces 34 interconnected to the base layer 24. Clamp slots in the prior art cast iron construction are also integrally formed with the die frame assembly. Yet, clamp slots have location placements and slot thicknesses and depths which are designed specific and unique to a customer's standards. Thus, the ability to simply interconnect the clamp slot pieces 34 having a slot 35 that is predesigned to these specific customer requirements to the base layer 24 of the modular plastic frame 18 (or any layer of the modular plastic frame 18, for that matter) again allows the modular die frame assembly 10 to be easily tailored to the specific needs of the customer, with minimal (or even no) changes to the production process (as would be required in the case of the prior art cast iron construction). As best illustrated in FIGS. 16-17, the plurality of working components 30, 34, 36, 40, 42, 43, 44, 45, 46, 54, 56, 60 for the modular die assembly 10 can include connecting pieces 36 disposed on adjacent sides of each clamp slot piece 34 and having a recess 38 for receiving a tongue (not expressly shown) of the adjacent clamp slot pieces 34 to assist in releasable securing the plurality of clamp slot pieces 34 to the base layer 24.

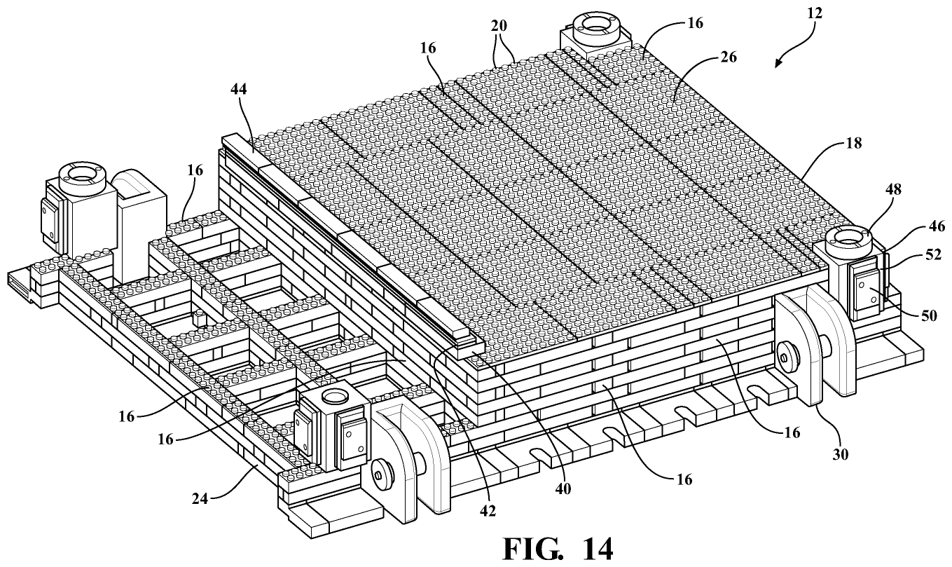

As best illustrated in FIGS. 14 and 18A, the plurality of working components 30, 34, 36, 40, 42, 43, 44, 45, 46, 54, 56, 60 for the modular die assembly 10 can also include a build-up block 40, a shim block 42 and a steel cutting sections 44 sequentially stacked upon one another. The build-up block 40 is releasably secured to one of the layers of the modular plastic frame 18, and then the shim block 42 mounts to the build-up block 40, such as with screws and dowels for fastening. The steel cutting sections 44 are then mounted on the shim block 42 to fasten a cutting tool to the modular plastic block 18 for use in forming the vehicle part with the modular die frame assembly 10. As best illustrated in FIG. 3, the plurality of working components for the upper die assembly 14 can additionally include a steel trim insert 43 and a sub plate 45 connected to a top layer 26 for the modular plastic frame 18 of the upper die assembly 14. In this case, the sub plate 45 is interconnected to the modular plastic frame 18 and the steel trim insert 43 is connected to the sub plate 45.

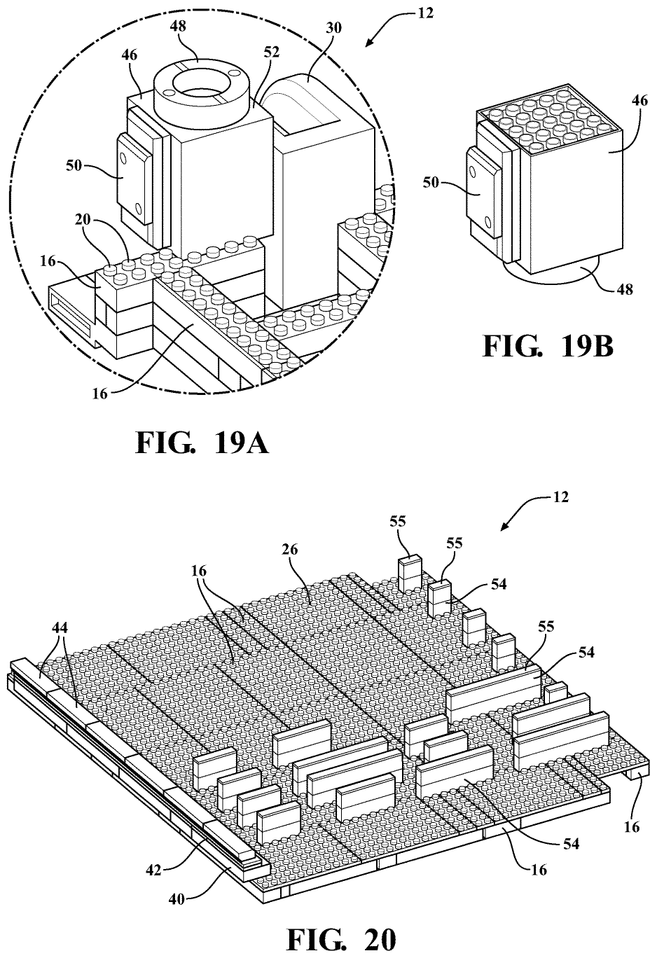

As best illustrated in FIGS. 2 and 19A, the plurality of working components 30, 34, 36, 40, 42, 43, 44, 45, 46, 54, 56, 60 for the modular die assembly 10 can also include a die heel block 46 releasably secured to one of the layers of the modular plastic frame 18. As best illustrated in FIG. 19A, the die heel block 46 includes a ring 48 and wear plates 50 which are steel components. However, unlike the prior art construction of the die heel block, a main body 52 of the die heel block 46 is comprised of plastic-not steel. Furthermore, die heel blocks in the prior art cast steel construction must be integrally formed with die frame assembly. Thus, the ability to releasably interconnect the die heel blocks 46 to the modular die frame assembly 10, such as via the working connectors 32 shown in FIG. 19B, provides for an easier and quicker production of the modular die frame assembly 10.

As best illustrated in FIGS. 2 and 20, the plurality of working components 30, 34, 36, 40, 42, 43, 44, 45, 46, 54, 56, 60 for the modular die assembly 10 can also include a plurality of skid (wear) blocks 54 releasably interconnected to the top layer 26 of the plastic molded frame 18. Each of the skid blocks 54 present a flat skid surface 55 for the blank to rest on when the upper and lower die frame assemblies 12, 14 are disposed in a closed position. Once again, unlike the prior art construction of the skid (wear) blocks, the skid blocks 54 in accordance with the subject disclosure are comprised of plastic-not steel. Furthermore, the skid (wear) blocks in the prior art cast steel construction must be integrally formed with the die frame assembly. Thus, the ability to releasably interconnect the skid blocks 54 to the modular die frame assembly 10 provides for an easier and quicker manufacturing process.

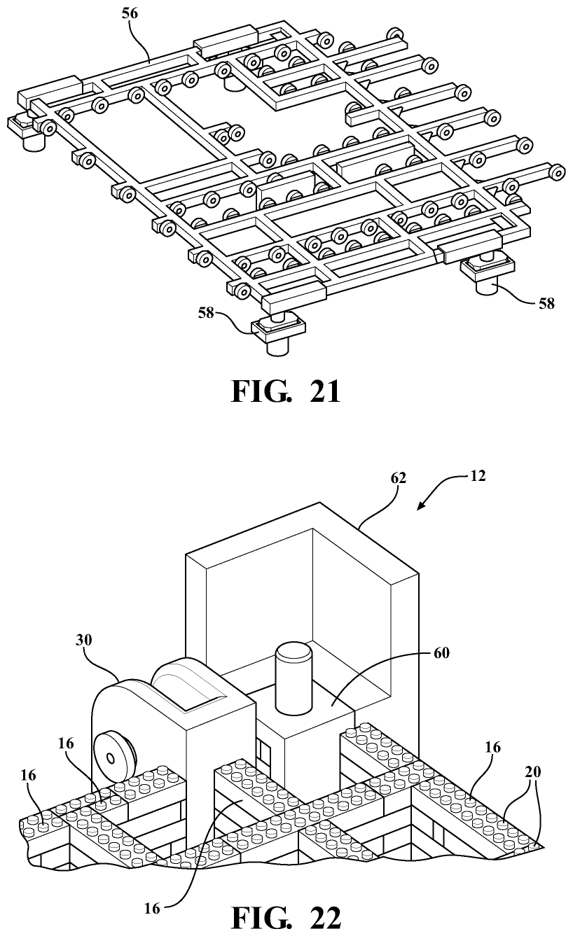

As best illustrated in FIGS. 2 and 21, the plurality of working components 30, 34, 36, 40, 42, 43, 44, 45, 46, 54, 56, 60 for the modular die assembly 10 can also include a lift table 56 interconnected to the top layer 26 of the modular plastic frame 18 for the lower die assembly 12. The prior art lift tables must be comprised of steel, such as tube steel weldments. However, in accordance with the subject disclosure, the lift table 56 can be 3D printed and then releasably interconnected to the top layer 26 via a nitro lifter assembly 58 which interconnects or snaps in place to the modular plastic frame 18. Thus, screws or dowels are not required to secure the lift table 56 to the modular plastic frame 18, as would be required in the prior art construction.

As best illustrated in FIGS. 3 and 22, the plurality of working components 30, 34, 36, 40, 42, 43, 44, 45, 46, 54, 56, 60 for the modular die assembly 10 can also include a guide pin block 60 for the upper die assembly 14 and a heel block 62 for the lower die assembly 12 each releasably interconnected to the modular plastic frame 18. Guide pin blocks and heel blocks in the prior art cast steel construction are integrally formed with die frame assembly. Thus, the ability to simply interconnect the guide pin block 60 and the heel block 62 to the modular plastic frame 18 allows the modular die frame assembly 10 to be easily tailored to the specific needs of the vehicle part, with minimal (or even no) changes to production process (as would be required in the case of the prior art cast steel construction).

Although not expressly illustrated, other working components for the modular die frame assembly 10 that could be releasably interconnected to the modular plastic frame 18 include tooling ball covers, target plates, feller gauge clips, XYZ tags, extensions, riser bar, swing templates, or the like. All the working components disclosure herein are non-limiting examples, and thus other working components could be secured the modular plastic frame 18 without departing from the scope of the subject disclosure.

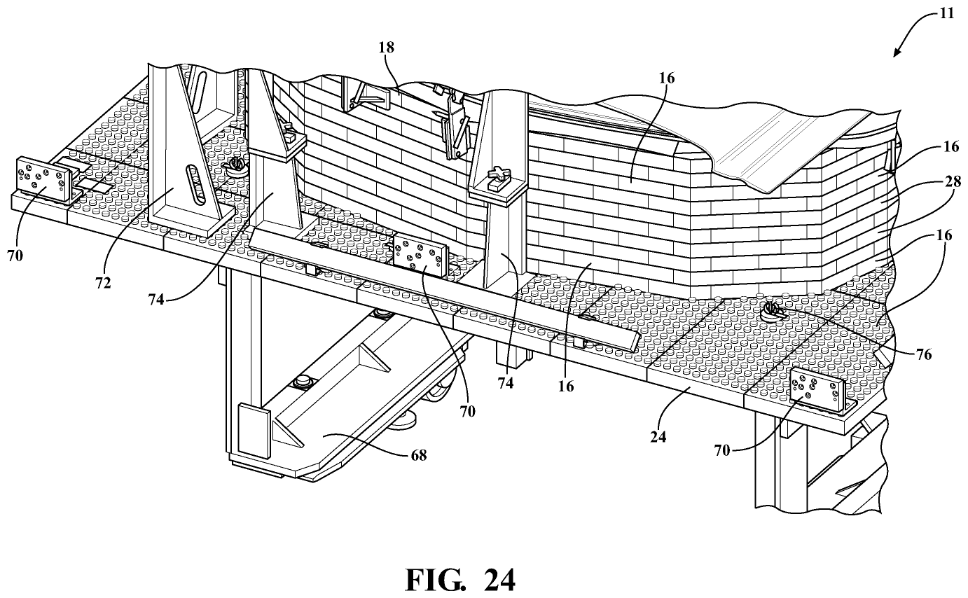

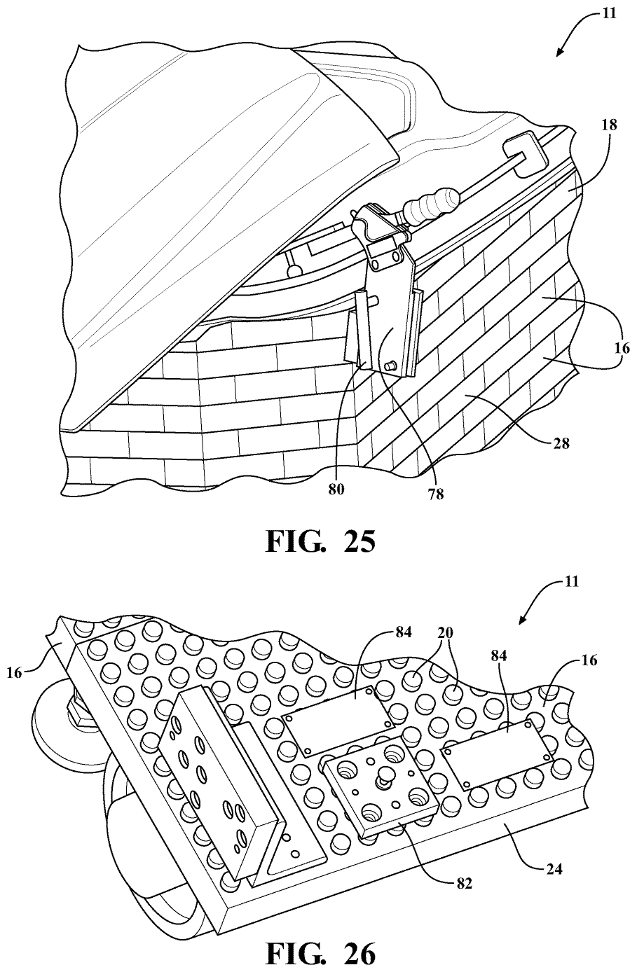

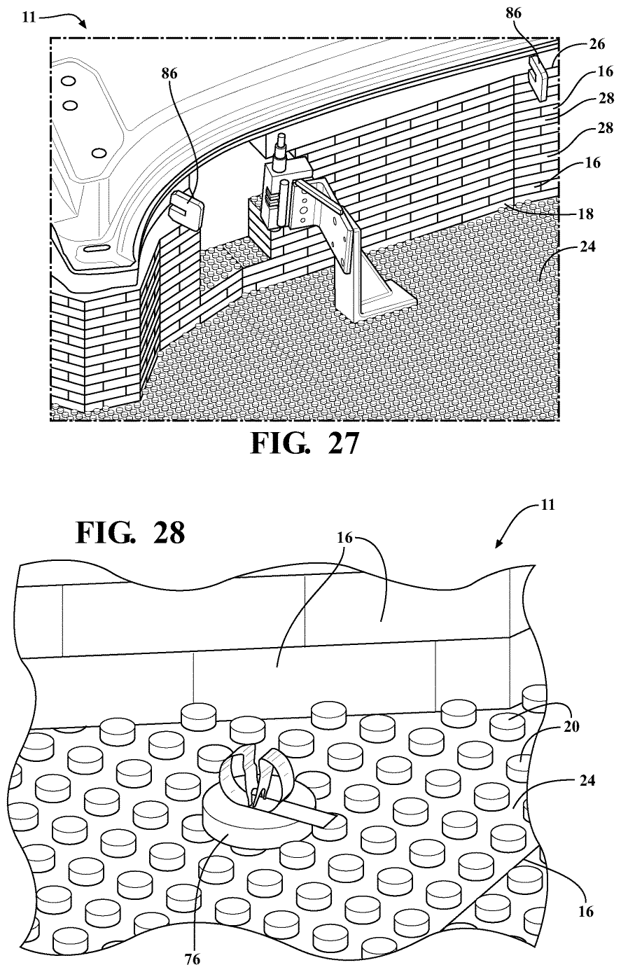

As best illustrated in FIG. 23, in the case of the checking fixture assembly 11, the modular plastic frame 18 can be placed and mounted on a movable cart 68 for allowing the checking fixture assembly 11 to be moved to the desired location for part testing and checking. As best illustrated FIGS. 24 and 28, the working components 70, 72, 74, 76, 78, 80, 82, 84, 86 for the checking fixture assembly 11 includes target plates 70, stanchions 72 and feeler holding clips 74 interconnected to a base layer 24 of the modular plastic frame 18. As further illustrated in FIG. 25, the working components 70, 72, 74, 76, 78, 80, 82, 84, 86 for the checking fixture assembly 11 can additionally including a swing template 78 and locking pin 80 interconnected to the modular plastic frame 18. As further illustrated in FIG. 26, the working components 70, 72, 74, 76, 78, 80, 82, 84, 86 for the checking fixture assembly 11 can additionally include a tooling ball holder 82 and informational plates 84 interconnected to the base layer. And as illustrated in FIG. 27, the working components 70, 72, 74, 76, 78, 80, 82, 84, 86 for the checking fixture assembly 11 can additionally include trim check aids 86 interconnected to the top layer 26.

Although not expressly illustrated in the drawings, the working component(s) for the checking fixture assembly 11 can also include fork lift pockets and/or sliding check rails, each interconnected to the modular plastic frame to complete production of the modular checking fixture assembly 11. These working components are exemplarly, and other working components could be interconnected to the modular plastic frame 18 without departing from the scope of the subject disclosure.

In addition to the advantages described above with regard to the use of the plastic molded blocks to form the checking fixture assembly 11, the use of plastic molded blocks 16 in the checking fixture assembly 11 also eliminates any paint processes required by customer standards. More specifically, since the plastic blocks 16 can be molded to a specific color, this eliminates the need to paint the steel cast checking fixture assemblies, as required in the prior art designs. Alternatively, the plastic blocks 16 can be molded to include dots added for optical scanning with a black background during use of the modular checking fixture assembly 11 to confirm accuracy of the vehicle part. Furthermore, since the plastic blocks 16 are molded or alternatively 3D printed, the plastic blocks 16 can be formed with holes in place, such that if fasteners are required to interconnect the plurality of plastic molded blocks 16 in the checking fixture assembly 11, the fasteners can quickly be installed on the plurality of plastic molded blocks 16 without the need to drill before threading.

It should be appreciated that the foregoing description of the embodiments has been provided for purposes of illustration. In other words, the subject disclosure it is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

1. A modular blank die assembly comprising:
a plurality of plastic molded blocks disposed in releasably interlocked relationship with one another to form a modular plastic frame;
each of the plurality of plastic molded blocks including at least one male connector disposed on a first side and at least one female connector disposed on a second side being arranged opposite to said first side;
said at least one male and female connector having complementary shapes for allowing the plurality of plastic molded blocks to be quickly and easily interconnected with one another to form said modular plastic frame; and
at least one working component interconnected to said modular plastic frame.

2. The modular blank die assembly as set forth in claim 1, wherein said at least one working component includes a working connector being shaped complementary to one of said male or female connectors for use in interconnecting said at least one working component to said modular plastic frame.

3. The modular blank die assembly as set forth in claim 1, wherein each of said male and female connectors having a circular cross-sectional shape.

4. The modular blank die assembly as set forth in claim 1, wherein said modular plastic frame extends from a base layer to a top layer and includes a plurality of intermediate layers disposed in stacked relationship therebetween.

5. The modular blank die assembly as set forth in claim 4, wherein said at least one working component includes a plurality of lift lugs connected to said base layer.

6. The modular blank die assembly as set forth in claim 4, wherein said at least one working component includes a plurality of skid blocks connected to said top layer of said modular plastic frame.

7. The modular blank die assembly as set forth in claim 6, wherein said plurality of skid blocks are comprised of plastic.

8. The modular blank die assembly as set forth in claim 17 wherein said lift table is 3D printed.

9. The modular blank die assembly as set forth in claim 1 wherein said at least one working component includes a die heel block having a main body comprised of plastic and including a ring and wear plates comprised of steel and secured to said main body.

10. The modular blank die assembly as set forth in claim 1, wherein said at least one working component includes a build-up block, a shim block and a steel cutting section sequentially stacked upon one another, wherein said build-up block is releasably interconnected to one of the layers of said modular plastic frame, the shim block mounts to said build-up block, and said steel cutting section is mounted on said shim block.

11. A checking fixture assembly comprising:
a plurality of plastic molded blocks disposed in releasably interlocked relationship with one another to form a modular plastic frame;
each of the plurality of plastic molded blocks including at least one male connector disposed on a first side and at least one female connector disposed on a second side being arranged opposite to said first side;
said at least one male and female connector having complementary shapes for allowing the plurality of plastic molded blocks to be quickly and easily interconnected with one another to form said modular plastic frame; and
at least one working component interconnected to said modular plastic frame.

12. The checking fixture assembly as set forth in claim 11, wherein said at least one working component includes a working connector being shaped complementary to one of said male or female connectors for use in interconnecting said at least one working component to said modular plastic frame.

13. The checking fixture assembly as set forth in claim 1, wherein each of said male and female connectors having a circular cross-sectional shape.

14. The checking fixture assembly as set forth in claim 1, wherein said modular plastic frame extends from a base layer to a top layer and includes a plurality of intermediate layers disposed in stacked relationship therebetween.

15. The checking fixture assembly as set forth in claim 11, wherein said at least one working component includes target plates, stanchions, risers, feeler holding clips, swing templates, locking pins, tooling ball holders, trim check aids, infomational plates, and/or tooling ball covers.

16. The modular blank die assembly as set forth in claim 4, wherein said at least one working component includes and a plurality of clamp slot pieces each having a slot connected to said base layer of said modular plastic frame.

17. The modular blank die assembly as set forth in claim 4, wherein said at least one working component includes a lift table releasably connected to said top layer of said modular plastic frame.

18. The modular blank die assembly as set forth in claim 4, wherein said at least one working component includes a sub plate releasably connected to said top layer of said modular plastic frame and a steel trim insert connected to said sub plate.

19. The modular blank die assembly as set forth in claim 4, wherein said at least one working component includes at least one of a guide pin block or a heel block releasably connected to said modular plastic frame.

20. The modular blank die assembly as set forth in claim 1, wherein said plurality of plastic molded blocks are glued in place.
